(19) United States
(12) Patent Application Publication
(10) Pub. No.: US 2015/0322279 A9
(43) Pub. Date: Nov. 12, 2015

(54) CARPET COATING COMPOSITIONS OF VINYL ACETATE HAVING IMPROVED WET AND/OR DRY STRENGTH

(71) Applicant: CELANESE INTERNATIONAL CORPORATION, Irving, TX (US)

(72) Inventors: David Lunsford, Fountain Inn, SC (US); Rajeev Farwaha, Belle Mead, NJ (US); Ernest Mitchell, H. Village, TX (US); Rebecca Stuart, Spartanburg, SC (US)

(21) Appl. No.: 14/407,361

(22) PCT Filed: Aug. 20, 2013
(86) PCT No.: PCT/US2013/055681

§ 371 Date: Dec. 11, 2014

Related U.S. Application Data
(60) Provisional application No. 61/691,329, filed on Aug. 21, 2012.

(51) Int. Cl. C09D 133/02; C09D 131/04; D06N 7/00; C09D 109/08

(52) U.S. Cl. CPC C09D 133/02; C09D 109/08; C09D 131/04; D06N 7/0073

(57) ABSTRACT

A latex coating composition for a carpet product comprising a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides and a second polymer formed from an α-olefin and an ethylenically unsaturated carboxylic acid. External crosslinker may also be used in the latex coating composition. The second polymer, preferably ethylene/acrylic acid, may be present in an amount from 1 to 10 parts of the second polymer per 100 parts of the total polymer.

### FILED OF INVENTION

The present invention relates to latex coating compositions for carpet products. In particular, the present invention relates to latex coating composition that comprise vinyl acetate and improve the wet and/or dry strength of the carpet product.

### BACKGROUND

Most conventional carpets comprise a primary backing with yarn tufts in the form of cut or uncut loops extending upwardly from this backing to form a pile surface. For tufted carpets, the yarn is inserted into the primary backing (frequently a woven or nonwoven material) by tufting needles and a precoat (i.e., a binder) is applied thereto. Other carpets are needle felt carpets, which are produced by compressing fibers onto textiles or other backing materials and then applying a binding agent so that the fibers are attached to the backing more durably.

Most residential and commercial carpets are also manufactured with a woven or nonwoven scrim (typically made from polypropylene), also referred to as a secondary backing, attached to the back of the carpet to provide dimensional stability. The scrim is attached to the precoated carpet back with another binder formulation typically referred to as a skipcoat. The skipcoat is applied to the scrim, and the scrim is then applied to the precoated backing of the carpet before the assembled carpet elements are sent into a curing oven. The purpose of the skipcoat is to provide a layer of material which will adhere the woven scrim to the back of the carpet.

An important characteristic of carpet is the ability to exhibit good physical properties even when the carpet is exposed to water. Carpets may be routinely exposed to water from steam cleaning processes. In such situations the wet strength of the carpet is important since inadequate wet strength can cause fraying of the carpet edges, fuzzing during wet cleaning or possibly delamination of the secondary backing from the carpet that results in carpet buckling. Such surface changes in carpet are undesirable and can reduce the useful lifetime of the carpet.

For both the precoat and the skipcoat, the physical properties of the binders are important to their successful utilization as carpet coatings. In this regard, there are a number of important requirements which must be met by such coatings. The coating must be capable of being applied to the carpet and dried using the processes and equipment conventionally employed in the carpet industry for latex, e.g., emulsion coating. The binder composition must provide excellent adhesion to the pile fibers to secure them firmly in the backing. The coating will also typically have a high loading of fillers such as calcium carbonate, clay, aluminum trihydrate, barite, feldspar, cullet, fly ash and/or recycled carpet backing.

The binders in coating compositions for carpet products are frequently emulsion polymers, i.e., latex dispersions, which can comprise copolymers of vinyl esters (such as vinyl acetate) and ethylene. Emulsion binders and carpet coating compositions based on vinyl ester/ethylene copolymers are disclosed, for example, in U.S. Pat. Nos. 4,735,986; 5,026,765; 5,849,389 and 6,359,076 and in U.S. Publication No. 2005/0287336, the entireties of which are incorporated herein by reference. These copolymers are prepared by polymerizing appropriate co-monomers in an aqueous emulsion. Such emulsions or dispersions can be stabilized by adding conventional surfactants (anionic, nonionic, or cationic) as emulsifiers. Such emulsions or dispersions may also be stabilized by including protective colloids such as those based on polyvinyl alcohols (PVOH), ionically modified starches, water-soluble starches, starch ethers, polyacrylic acid, carboxymethyl cellulose, natural gums, gelatin, synthetic polymers, or water-soluble cellulose ethers such as hydroxyethyl cellulose (HEC).

Carpet coatings that include vinyl acetate/ethylene have found limited use in carpet coatings due to their poor wet strength as compared to carpet coatings that include styrene/butadiene. U.S. Pat. No. 6,359,076 describes a carpet back coating composition which is an aqueous emulsion polymerization product of ethylene, vinyl acetate, and an ethylenically unsaturated hydroxy-functional monomer to form an emulsion copolymer which is combined with a crosslinking agent selected from the group consisting of multifunctional aziridine, multifunctional isocyanate, and multifunctional epoxide.

U.S. Pub. No. 2010/0279113 describes a coating composition comprising (a) a dispersion, and (b) a crosslinker. The dispersion comprises at least one or more base polymers selected from the group consisting of an ethylene-based thermoplastic polymer, a propylene-based thermoplastic polymer, and mixtures thereof; at least one or more stabilizing agents; and a fluid medium.

U.S. Pub. No. 2010/0230062 describes a coating composition comprising (a) a dispersion, and (b) a solution acrylic polymer, an emulsion polymer latex, or combinations thereof. The dispersion comprises at least one or more base polymers selected from the group consisting of an ethylene-based thermoplastic polymer, a propylene-based thermoplastic polymer, and mixtures thereof; at least one or more stabilizing agents; and a fluid medium.

Notwithstanding the availability of a variety of carpet coating and adhesive compositions based on stabilized vinyl acetate/ethylene (VAE) latex emulsion/dispersion binders, it would be advantageous to identify and select specific types of such binder emulsions/dispersions which exhibit a desirable balance of properties which make them especially useful in preparing textile structures such as carpet products.

The need therefore exists for improved VAE-based coating compositions and processes for making such coating compositions having desired binding strength characteristics for carpet manufacturing applications.

### SUMMARY OF THE INVENTION

It has now been discovered that by a certain blend of a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides, a second polymer formed from an α-olefin and an ethylenically unsaturated carboxylic acid, and optionally an external crosslinker, latex coating compositions may be prepared having especially desirable physical properties, rendering them well-suited for use in adhesive compositions such as precoat and/or skipcoat binders in carpet manufacture. In particular, carpet products having particularly high dry and/or wet tuft bind values may be formed using the processes and latex coating compositions of the present invention.

In a first embodiment, the present invention is directed to a latex coating composition for a carpet product comprising a first polymer, a second polymer, and at least one external crosslinker. The composition may comprise at least 1 part of the second polymer per 100 parts of the total polymer, e.g., at least 3 parts of the second polymer per 100 parts of the total polymer. In one embodiment, the first polymer may comprise one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides. The second polymer may comprise an α-olefin and an ethylenically unsaturated carboxylic acid. In one embodiment, the ethylenically unsaturated carboxylic acid of the second polymer has the formula:

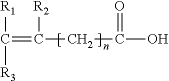

wherein R₁ is hydrogen or C₁-C₁₆ alkyl, R₂ and R₃ are independently selected from hydrogen, C₁-C₁₆ alkyl, carboxylic acid moiety or C₁-C₁₆ alkyl carboxylic acid moiety; and n is 0 or 1. Preferably, the second polymer comprises an ethylene acrylic acid polymer, and wherein the ethylene acrylic acid polymer comprises from 70 wt. % to 90 wt. % of ethylene, based on total main co-monomers of the second polymer.

The external crosslinker may be selected from the group consisting of ammonium zirconium carbonate, zinc ammonium carbonate, potassium zirconium carbonate, and titanium acetylacetonate, ethylcitrate zirconate, alkanolamine titanate, alkanolamine zirconates, and titanium lactates. In one embodiment, the composition comprises from 0.1 to 10 parts crosslinker per 100 parts of the total polymer, e.g., 0.2 to 1 parts. In another embodiment, the external crosslinker may be optional.

In one embodiment, the latex coating composition may comprise from 50 to 500 parts filler per 100 parts of the total polymer, e.g., from 100 to 400 parts filler per 100 parts of the total polymer or from 150 to 270 parts filler per 100 parts of the total polymer. The filler may vary depending on the product and is generally selected from the group consisting of calcium carbonate, clay, aluminum trihydrate, barite, feldspar, cullet, fly ash and/or recycled carpet backing.

In a second embodiment, the present invention is directed to carpet product, such as a loop carpet product, comprising at least one substrate and at least one adhesive layer associated with the at least one substrate, the adhesive layer being formed from a latex coating composition comprising a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides; a second polymer formed from an α-olefin and ethylenically unsaturated carboxylic acids; and at least one external crosslinker.

The carpet product may have a wet and/or dry strength improvement that is greater than 5% over a carpet product having only the first polymer in the latex coating composition. In particular, loop carpet products may have a wet tuft bind of greater than 16 N, e.g. greater than 17 N or greater than 20 N. The loop carpet product may have a dry tuft bind of greater than 30 N, e.g. greater than 32 N or greater than 35 N. In one embodiment, the loop carpet product has both a wet tuft bind of greater than 16 N and a dry tuft bin of greater than 30 N.

In a third embodiment, the present invention is directed to a process for producing a carpet product comprising providing yarns which are tufted into a primary backing material; applying a binder emulsion composition to the backing material, wherein the binder emulsion comprises: a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and amides of ethylenically unsaturated carboxylic acids; a second polymer formed from an α-olefin and ethylenically unsaturated carboxylic acids; and at least one crosslinker; and drying the binder emulsion composition under conditions effective to adhere the tufted yarns into the backing material.

In a fourth embodiment, the present invention is directed to a latex coating composition comprising a first polymer formed from one or more monomers selected from the group consisting of vinyl esters of a C₁-C₁₈ alkanoic acid, ethylenically unsaturated carboxylic acids, and esters of ethylenically unsaturated carboxylic acids; a second polymer formed from ethylene and acrylic acid; and optionally at least one external crosslinker.

In a fifth embodiment, the present invention is directed to a latex coating composition comprising a first polymer comprising a blend, a second polymer formed from an α-olefin and an ethylenically unsaturated carboxylic acid; and at least one external crosslinker. The first polymer comprises a blend of a first blend polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides, and a second blend polymer, preferably at least 3 parts per 100 parts of total polymer, formed from a vinylaromatic and a diene. Preferably the second blend polymer comprise styrene and 1,3-butadiene. In one embodiment, the first polymer comprises a weight ratio of first blend polymer to second blend polymer of 40/60 to 60/40.

### DETAILED DESCRIPTION OF THE INVENTION

The invention, in one embodiment, is directed to latex coating compositions useful as coating and adhesive compositions incorporated into textile structures, e.g., carpet products. The latex coating compositions comprise a first polymer, a second polymer, and optionally an external crosslinker. The first polymer is a polymer of at least one monomer selected from vinyl esters of a C₁-C₁₈ alkanoic acid, ethylenically unsaturated carboxylic acids, esters of ethylenically unsaturated carboxylic acids, vinylaromatics, and vinyl halides, and the second polymer comprises at least an α-olefin and an ethylenically unsaturated carboxylic acid. The latex coating compositions surprisingly and unexpectedly provide particularly desirable adhesive characteristics, in particular dry and/or wet tuft bind values, when used in forming textiles. The latex coating compositions are particularly useful for use as precoats or skipcoats in the formation of carpet products. The invention is accordingly also directed to carpet products formed using the inventive latex coating compositions and to processes for forming such carpet products.

The extent or tenacity to which the yarn is affixed to a carpet backing material is referred to as “tuft bind” strength. Carpets with sufficient dry and/or wet tuft bind strength exhibit good wear resistance and have longer service lives. In order to have good performance characteristics, the adhesive backing material should substantially penetrate the yarn (fiber bundle) exposed on the backside of the primary backing material and should substantially consolidate individual fibers within the yarn. Good penetration of the yarn and consolidation of the fibers leads to good abrasion resistance. Moreover, in addition to good tuft bind strength and abrasion resistance, the adhesive material preferably imparts or allows good flexibility to the carpet in order to facilitate installation of the carpet. In a preferred embodiment, the latex coating composition may be used in an adhesive composition, e.g., carpet precoat or skipcoat binder, to form a carpet composition having a dry tuft bind value greater than 30 N, e.g. greater than 32 N or greater than 35 N, as determined by ASTM D-1335. In a preferred embodiment, the latex coating composition may be used in an adhesive composition, e.g., carpet precoat or skipcoat binder, to form a carpet composition having a wet tuft bind value greater than 16 N, e.g. greater than 17 N or greater than 20 N, as determined by a modified ASTM-D 1335, in which the samples are soaked in water and excess water is removed before testing for wet tuft bind values. In some embodiments, the latex composition may be used in an adhesive composition that has both a dry tuft bind value of greater than 30 N and a wet tuft bind value of greater than 16 N. The dry and wet tuft bind values discussed above are for loop carpets. Cut pile carpet typically has a lower tuft bind than loop carpets, but similar improvements would also be expected for cut pile carpet.

Since tuft bind values may vary depending on carpet type, the improvement in the tuft bind strength, either dry or wet, may be characterized as a “dry tuft bind percentage increase” or “wet tuft bind percentage increase” relative to a similar carpet formed using a coating composition containing the first polymer, but not the second polymer and/or external crosslinker. In this aspect, the latex coating compositions of the invention may provide carpeting having an increased dry tuft bind percentage of greater than 5%, e.g., greater than 10%, or greater than 20%. The latex coating compositions of the invention may provide carpeting having an increased wet tuft bind percentage of greater than 5%, e.g., greater than 20%, or greater than 30%.

To obtain the desired improvements in dry and/or wet tuft binding, a relatively small amount of the second polymer is added to the latex coating composition. In one embodiment, the composition comprises at least 1 part of the second polymer per 100 parts of the total polymer, e.g., at least 3 parts of the second polymer per 100 parts of the total polymer. In terms of ranges, the composition comprises from 1 to 10 parts of the second polymer per 100 parts of the total polymer, e.g., from 2 to 5 parts of the second polymer per 100 parts of the total polymer.

In some embodiments, the latex coating compositions of the invention may comprise one or more crosslinkers. When used, crosslinking may occur after drying to remove water. Suitable external crosslinkers include carbonates such as ammonium zirconium carbonate (AZC), zinc ammonium carbonate (ZAC), potassium zirconium carbonate (KZC), titanium acetylacetonate, ethylcitrate zirconate, alkanolamine titanate, alkanolamine zirconates, and titanium lactates. Titanium acetylacetonate, ethylcitrate zirconate, alkanolamine titanate, alkanolamine zirconates, and titanium lactates are commercially available as Tyzor™ from DuPont. Additional metal carbonates may also be used with embodiments of the present invention. When present, the external crosslinker may be present in the latex coating composition in an amount from 0.1 to 10 parts crosslinker per 100 parts of the total polymer, e.g., 0.2 to 1 parts crosslinker per 100 parts of the total polymer or from 0.3 to 0.5 parts crosslinker per 100 parts of the total polymer.

The second polymer preferably is not intimately mixed with the first polymer, although it is contemplated that the external crosslinker, if present, may effectively crosslink carboxyl groups on the first polymer with carboxyl group on the second polymer. In another embodiment, the latex coating composition of the first and second polymer may be substantially free of external crosslinkers.

The first and second polymers used to form the latex coating compositions described herein are preferably made in separate processes and are blended together to form the inventive latex coating composition.

### First Polymer

The first polymer comprises one or more monomers selected from vinyl esters of a C₁-C₁₈ alkanoic acid, ethylenically unsaturated carboxylic acids, esters of ethylenically unsaturated carboxylic acids, vinylaromatics, and vinyl halides. The first polymer preferably is formed by the emulsion polymerization of at least a vinyl ester of an alkanoic acid having from 1 to 18 carbon atoms and ethylene, and optionally one or more additional co-monomers such as ethylenically unsaturated carboxylic acids, esters of ethylenically unsaturated carboxylic acids. Examples include vinyl esters of carboxylic acids having 1 to 8 carbon atoms, such as, for example, vinyl formate, vinyl acetate, vinyl butyrate, vinyl isobutyrate, vinyl valerate, and vinyl 2-ethylhexanoate. Suitable monomers also include vinyl esters of saturated, branched monocarboxylic acids having 9, 10 or 11 carbon atoms in the acid radical, e.g., versatic acid, and vinyl esters of relatively long-chain, saturated and unsaturated fatty acids, for example vinyl esters of fatty acids having 8 to 18 carbon atoms, such as, for example, vinyl neodecanoate, vinyl laurate and vinyl stearate. Vinyl acetate, vinyl esters of versatic acid and vinyl laurate are preferred. Of the foregoing, vinyl acetate is a preferred monomer because of its ready availability and low cost.

Most preferably, the first polymer comprises a vinyl ester and an α-olefin, such as ethylene. The vinyl ester, e.g., vinyl acetate, content of the first polymer used in this embodiment will range from about 70 to 95 pphm, e.g., from 72 pphm to 88 pphm, from about 75 pphm to 85 pphm, or from about 78 pphm to 82 pphm (parts per hundred based on total monomers in the first polymer). The ethylene may vary from 2 pphm to 30 pphm, e.g., from 5 to 20 pphm or from 10 to 20 pphm. More preferably, ethylene will be present in the first polymer in an amount ranging from 2 pphm to 15 pphm.

If the first polymer further comprises a further co-monomer, the further monomer may be present, for example, in an amount from 0.1 to 10 pphm, e.g., from 0.1 to 5 pphm. Such optional further co-monomers, for example, may be selected from the group consisting of ethylenically unsaturated carboxylic acids, esters of ethylenically unsaturated carboxylic acids, vinylaromatics, and vinyl halides. Suitable vinyl halides include vinyl fluoride, vinylidene fluoride, vinyl chloride, vinylidene chloride, and vinyl bromide. Examples of suitable monomers of vinylaromatics include styrene, vinyltoluene and alpha-methylstyrene. Styrene is particularly preferred, and may be used in combination with a diene, such as 1,3-butadiene. In one embodiment, styrene-butadiene rubber (SBR) may be used in addition to the first polymer to form a blend of VAE/SBR or a VAE terpolymer/SBR. Blends of VAE or VAE terpolymers and SBR may be in a weight ratio of 40/60 to 60/40 or about 50/50.

Examples of suitable monomers of ethylenically unsaturated carboxylic acids, or esters of ethylenically unsaturated carboxylic acids may have 3 to 12 carbon atoms, such as esters of acrylic acid, methacrylic acid, crotonic acid, maleic acid, itaconic acid and fumaric acid, and esters thereof. Preferred esters of α,β-unsaturated carboxylic acids include alkyl(meth)acrylates (i.e. alkyl esters of acrylic acid or of methacrylic acid). Examples of these are methyl acrylate, ethyl acrylate, propyl acrylate, butyl acrylate, 2-ethylhexyl acrylate, methyl methacrylate, ethyl methacrylate, propyl methacrylate, n-butyl methacrylate, tert-butyl methacrylate, isobutyl methacrylate, 2-ethylhexyl methacrylate, cyclohexyl methacrylate, and cyclohexyl acrylate. Examples for esters of unsaturated dicarboxylic acids are dibutyl maleate and monooctylmaleate. These esters can be used alone or in the form of a combination of two or more esters.

Optional co-monomers can also be selected from the group consisting of vinyl esters which are not vinyl acetate, alpha-olefins which are not ethylene, vinyl aromatics, esters of ethylenically unsaturated monocarboxylic acids, and diesters of ethylenically unsaturated dicarboxylic acids.

Various types of first polymers may be used in the present invention. In one embodiment, the first polymer comprises vinyl ester of a C₁-C₁₈ alkanoic acid, α-olefin, and ethylenically unsaturated carboxylic acids or esters of ethylenically unsaturated carboxylic acids. In another embodiment, the first polymer comprises vinyl ester of a C₁-C₁₈ alkanoic acid, and ethylenically unsaturated carboxylic acids or esters of ethylenically unsaturated carboxylic acids.

Suitable monomer combinations for the first polymer include vinyl acetate/ethylene, vinyl acetate/ethylene/butyl acrylate, vinyl acetate/ethyl acrylate, vinyl acetate/2-ethylhexyl acrylate, vinyl acetate/butyl acrylate, vinyl acetate/vinyl propionate/ethylene, vinyl acetate/vinyl neodecanoate/ethylene, vinyl acetate/ethylene/vinyl chloride, vinyl acetate/ethylene/methyl acrylate, vinyl acetate/ethylene/methyl methacrylate, vinyl acetate/ethylene/acrylic acid, vinyl acetate/ethylene/butyl acrylate/acrylic acid, vinyl acetate/ethylene/ethyl acrylate, or vinyl acetate/ethylene/vinyl esters of versatic acid.

Optionally, the first polymer further comprises a co-monomer that acts as an internal crosslinker. For example, the first polymer optionally further comprises a polyethylenically unsaturated co-monomer selected from the group consisting of triallyl cyanurate, triallyl isocyanurate, diallyl maleate, diallyl fumarate, divinyl benzene, and diallyl phthalate. The incorporation of one or more of these co-monomers may beneficially increase branching or crosslinking, increasing molecular weight and improving performance. Preferred co-monomers of this type included diallyl maleate, diallyl fumarate and diallyl phthalate. This type of polyethylenically unsaturated co-monomer will be generally present in the first polymer, if at all, in an amount from 0.05 pphm to 10 pphm, e.g., from 0.1 to 5 pphm or from 0.1 to 1 pphm.

Optionally, the first polymer may further comprise silanes and glycidyl methacrylate (GMA) in the polymer backbone. Particularly preferred silanes are vinylmethyl-dimethoxy-silane, vinylmethyl-diethoxy-silane, vinylmethyl-di-n-propoxy-silane, vinylmethyl-di-iso-propoxy-silane, vinylmethyl-di-n-butoxy-silane, vinylmethyl-di-sec-butoxy-silane, vinylmethyl-di-tert-butoxy-silane, vinylmethyl-di-(2-methoxy-isopropyloxy)-silane, and vinylmethyl-dioctyloxy-silane. The silanes and/or GMA will be generally present in the first polymer, if at all, in an amount from 0.1 pphm to 20 pphm, e.g., from 0.2 to 5 pphm.

Since they are preferably formed in separate processes and then blended together, the first polymer preferably is not intimately mixed with the second polymer and preferably is not crosslinked therewith. Depending on the composition of the first polymer, and without being bound by theory, to the extent a crosslinker is employed in the first polymer, it is preferred that such crosslinker acts to crosslink the first polymer with itself, but does not act to crosslink the first polymer with the second polymer.

In accordance with one embodiment, the first polymer of the dispersions produced herein for use in carpet manufacture may be prepared to have a Tg of from about −10° C. to about 25° C., e.g., from −5° C. to 20° C. Tg of the vinyl acetate ethylene polymers may be controlled by adjusting the ethylene content, i.e., generally the more ethylene present in the polymer relative to other co-monomers, the lower the Tg.

The dispersions comprising the first polymer hereinbefore described can be prepared using conventional emulsion polymerization procedures which result in the preparation of emulsions in aqueous latex form. Such procedures are described in general, for example, in U.S. Pat. No. 5,849,389, the entirety of which is incorporated herein by reference, as well as in Chorng-Shyan Chern, Principles and Applications of Emulsion Polymerization, John Wiley and Sons Inc. (2008), the entirety of which is incorporated herein by reference.

In a typical polymerization procedure, the vinyl ester, preferably vinyl acetate, ethylene, and optionally one or more additional third co-monomers can be polymerized in an aqueous medium under pressures not exceeding 100 atmospheres in the presence of a catalyst and at least one emulsifying agent. The aqueous system can be maintained by a suitable buffering agent at a pH of 2 to 6, with the catalyst being added incrementally or continuously. More specifically, vinyl acetate and 50% to 75% of the other co-monomer(s), if any, can be suspended in water and thoroughly agitated in the presence of ethylene under the working pressure to effect solution of the ethylene in the mixture up to the substantial limit of its solubility under the conditions existing in the reaction zone. The vinyl ester, e.g., vinyl acetate, and other co-monomers, if any, can then be gradually heated to polymerization temperature.

In some embodiments, the first emulsion is substantially free of, colloidal stabilizers such as polyvinyl alcohol, optionally comprising less than 1.5 pphm polyvinyl alcohol, less than 1 pphm polyvinyl alcohol, or less than 0.5 pphm polyvinyl alcohol (parts per hundred based on total monomers in the first polymer). It is contemplated, however, that some protective colloids, such as hydroxyethyl cellulose may be used. In other embodiments, from 1 to 20 pphm polyvinyl alcohol may be used in place of or as a substitute for surfactants.

The homogenization period is generally followed by a polymerization period during which the catalyst, which comprises a main catalyst or initiator, and may include an activator, is added incrementally or continuously together with the remaining co-monomers, if any, e.g., one or more third co-monomers. If employed, the one or more third co-monomers may be added either as pure monomer or as a premixed emulsion.

Suitable polymerization catalysts include the water-soluble free-radical-formers generally used in emulsion polymerization, such as hydrogen peroxide, sodium persulfate, potassium persulfate and ammonium persulfate, as well as tert-butyl hydroperoxide, optionally in amounts from 0.01% and 3% by weight, preferably 0.01% and 1% by weight based on the total amount of the emulsion. The catalysts can be used together with reducing agents such as sodium formaldehyde-sulfoxylate, ferrous salts, sodium dithionite, sodium hydrogen sulfite, sodium sulfite, sodium thiosulfate, as redox catalysts in amounts from 0.01% to 3% by weight, preferably from 0.01% to 1% by weight, based on the total amount of the emulsion. The free radical-formers can be charged in the aqueous emulsifier solution or be added during the polymerization in doses.

The manner of combining the polymerization ingredients can be by various known monomer feed methods, such as, continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

The emulsion polymerization used to prepare the first polymer in aqueous latex form is preferably carried out in the presence of a stabilization system which comprises one or more anionic, cationic, and/or nonionic surfactants as emulsifiers. Suitable nonionic surfactants which can be used as emulsifiers in the emulsion stabilizing system of the latex coating compositions herein include polyoxyethylene condensates. A wide variety of nonionic surfactants of this type are disclosed in the hereinbefore-referenced U.S. Pat. No. 5,849,389. Suitable emulsifiers may also include, for example, alkyl sulfonates, alkylaryl sulfonates, alkyl sulfates, sulfates of hydroxylalkanols, alkyl and alkylaryl disulfonates, sulfonated fatty acids, sulfates and phosphates of polyethyoxylated alkanols, alkyl quaternary ammonium salts, and alkyl quaternary phosphonium salts.

Suitable anionic surfactants that can be used as emulsifiers in the latex coating compositions or adhesive compositions formed therefrom, e.g., carpet precoat or skipcoat binders, include alkyl aryl sulfonates, alkali metal alkyl sulfates, sulfonated alkyl esters and fatty acid soaps. Representative anionic emulsifiers include the alkyl aryl sulfonates, alkali metal alkyl sulfates, the sulfonated alkyl esters, and fatty acid soaps. Specific examples include sodium dodecylbenzene sulfonate, sodium butylnaphthalene sulfonate, sodium lauryl sulfate, disodium dodecyl diphenyl ether disulfonate, N-octadecyl sulfosuccinate and dioctyl sodiumsulfosuccinate. Additional anionic surfactants of this type are also disclosed in the hereinbefore-referenced U.S. Pat. No. 5,849,389.

Conventionally, various protective colloids have been used to stabilize vinyl acetate/ethylene emulsions of the type hereinbefore described, instead of or in addition to the surfactant emulsifiers. For the dispersions to be used in textile structures, up to about 2 wt. % of a protective colloid such as cellulose ether or other conventional protective colloid-forming materials may be used. The use of hydroxyethyl cellulose, for example, may be acceptable or desired in combination with one or more surfactants. Dispersions used for this purpose can also be substantially free of protective colloids. In some embodiments, the latex coating compositions of the invention are free or substantially free of polyvinyl alcohol, optionally comprising less than 1.5 pphm polyvinyl alcohol, less than 1 pphm polyvinyl alcohol, or less than 0.5 pphm polyvinyl alcohol. In other embodiments, a small amount of polyvinyl alcohol may be employed so long as it does not render the first emulsion incompatible with the second emulsion. For example, in some embodiments, the first emulsion may comprise from about 1 to 2 wt. % polyvinyl alcohol in latex coating compositions for use in forming textile structures such as tufted carpets. In still other embodiment, more polyvinyl alcohol may be used to stabilize the first polymer.

The first polymer may be stabilized with emulsifier agents or surfactants, or a protective colloidal such as polyvinyl alcohol or hydroxy-ethyl cellulose. As known in the art, the choice of stabilizer may influence mean particle diameter, dw. Generally, when the first polymer is prepared with an emulsifiers or surfactants the dispersions prepared may generally have a mean particle diameter, dw, ranging from 50 to 500 nm. The particle size of the first emulsion can be regulated by the quantity of emulsifying agents employed. To obtain smaller particle sizes, greater amounts of emulsifying agents are used. As a general rule, the greater the amount of the emulsifying agent employed, the smaller the average particle size. When the first polymer is prepared with a protective colloidal, the first polymer may have a particle diameter, dw, that is greater than 500 nm.

The viscosity of the dispersion may be less than 10,000 mPas, e.g., less than 5,000 mPas or less than 2,000 mPas, as measured with a Brookfield viscometer at 25° C.

Following polymerization, the solids content of the resulting aqueous polymer dispersions can be adjusted to the level desired by the addition of water or by the removal of water by distillation. Generally, the desired level of polymeric solids content is from 40 wt. % to 70 wt. % based on the total weight of the emulsion, e.g., from 40 wt. % to 60 wt. %, and more preferably from 50 wt. % to 60 wt. %.

### Second Polymer

The second polymer preferably is formed by the free radial polymerization of α-olefin, preferably ethylene, propylene, or mixtures thereof, and ethylenically unsaturated carboxylic acids. In one embodiment, the second polymer is the reactor product of an olefin having from 2 to 8 carbon atoms and an ethylenically unsaturated carboxylic acid having from 3 to 8 carbon atoms. In one embodiment, the ethylenically unsaturated carboxylic acid has the formula of

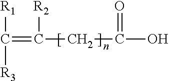

wherein R₁ is hydrogen or C₁-C₁₆ alkyl, R₂ and R₃ are independently selected from hydrogen, C₁-C₁₆ alkyl, carboxylic acid moiety or C₁-C₁₆ alkyl carboxylic acid moiety; and n is 0 or 1. The C₁-C₁₆ alkyl group, e.g., preferably C₁-C₈ alkyl group, may be straight or branched. The C₁-C₁₆ alkyl carboxylic acid moiety may be a methyl carboxylic acid moiety. In one embodiment R₁, R₂, and R₃ are hydrogen.

Examples of suitable monomers of ethylenically unsaturated carboxylic acids may have 3 to 12 carbon atoms, such as esters of acrylic acid, methacrylic acid, crotonic acid, maleic acid, itaconic acid, and fumaric acid. Most preferably the second polymer may comprise acrylic acid, or methacrylic acid. In one embodiment, the second polymer may also comprise one or more esters of ethylenically unsaturated carboxylic acids. Optionally, the esters may include methyl acrylate, ethyl acrylate, propyl acrylate, butyl acrylate, 2-ethylhexyl acrylate, methyl methacrylate, ethyl methacrylate, propyl methacrylate, n-butyl methacrylate, tert-butyl methacrylate, isobutyl methacrylate, 2-ethylhexyl methacrylate, cyclohexyl methacrylate, and cyclohexyl acrylate. Examples for esters of unsaturated dicarboxylic acids are dibutyl maleate and monooctylmaleate. These esters can be used alone or in the form of a combination of two or more esters.

The ethylene content of the second polymer may vary from 70 pphm to 90 pphm, e.g., from 75 to 85 pphm. The ethylenically unsaturated carboxylic acids, or esters of ethylenically unsaturated carboxylic acids may be present in an amount from 10 to 30 pphm, e.g., from 15 to 25 pphm.

A suitable second polymer may comprise a copolymer resin of ethylene/acrylic acid, ethylene/methacrylic acid, ethylene/maleic acid, or ethylene/itaconic acid. In some embodiments, the carboxylic acid groups of the copolymer may be neutralized with an alkali metal, or alkaline earth metal, or zinc. Commercially this second polymer may be available as Iotek™ Ionomers 8020 from ExxonMobile Corp., Suryln™ 8020 Ionomer Resin from DuPont, Berbond™ 8020 from Bercen, or Michem™ Prime 4990R from Michelman, Inc.

In one embodiment the second polymer preferably does not comprise monomers of vinyl esters, vinylaromatics, or 1,3-butadiene.

The second polymer is a thermoplastic and may be prepared free radical polymerization under high pressure and elevated temperature. A free radial initiator may be used. A solvent may be used. Once the second polymer is produced, it may be dispersed in solution prior to be blended with the first polymer. The polymeric solids content of the second polymer may be from 20 wt. % to 60 wt. % based on the total weight of the solution, e.g., from 25 wt. % to 50 wt. %.

### Adhesive Compositions

The textile structures herein will generally have the latex coating compositions of the invention incorporated thereinto as part of an adhesive composition. Such adhesive compositions can contain, in addition to the latex coating composition hereinabove described, a variety of conventional additives to modify the properties thereof. Among these additives may be included fillers, pigments, stabilizers, emulsifiers, thickeners, flame retardants, antimicrobials, biocides, foaming agents, dispersants, defoamers, etc. In one embodiment, the textile structure, e.g., carpet product, may comprise from 50 to 500 parts filler per 100 parts (phr) of the total polymer, e.g., from 100 to 300 phr. Suitable fillers may include calcium carbonate, clay, aluminum trihydrate, barite, feldspar, cullet, fly ash and/or recycled carpet backing. Carbon black may be used in combination with any of these fillers. The textile structures which contain the adhesive compositions prepared from the latex coating compositions described herein can have a weight per unit area from 200 to 3000 g/m², e.g., from 500 to 1200 g/m².

The viscosity of the adhesive composition may vary widely depending primarily on the desired use of the composition. In general terms, the adhesive composition may have a viscosity ranging from 2,000 to 80,000 cP. Lower viscosities, e.g., from 4,000 to 15,000 cP, may be preferred for adhesive compositions for use in precoat applications, while higher viscosities, e.g., from 10,000 to 18,000 cP, may be desired for skip coat compositions using a roller and pan process, and viscosities from 25,000 to 45,000 cP or higher may be desired for Tilitson-type coaters used in skipcoat applications.

The adhesive compositions of the invention, e.g., carpet precoat or skipcoat formulations, may comprise the latex coating composition together optionally with a filler, such as calcium carbonate, and the usual carpet coating additives, which may include, for example, thickeners such as sodium polyacrylates, foaming agents, biocides, and dispersants. The latex coating composition or adhesive composition described herein may also contain fixed alkali to maintain a pH of between 8.5 and 11, more preferably between 9 and 10.

Thus, in another embodiment, the invention is directed to an adhesive composition, preferably a carpet precoat or skipcoat formulations, comprising an aqueous polymer dispersion and fixed alkali to achieve a pH of 8.5 to 11, the latex coating composition having dispersed therein a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides, and a second polymer formed from an α-olefin and an ethylenically unsaturated carboxylic acid, wherein the latex coating composition is stabilized with anionic and/or non-ionic emulsifiers. Preferably, the latex coating composition is formed as a blend of a first emulsion comprising a vinyl acetate ethylene polymer, or VAE terpolymer, and a second emulsion comprising at least ethylene/acrylic acid, as described above.

In yet another embodiment, the latex coating composition described herein can be used, generally in combination with a pigment, as a coating formulation for other substrates including paper such as freesheet and groundwood grades; paper board; labels; paper products used for newspapers, advertisements, poster, books or magazines; and building substrates such as wall paper, wall board, or ceiling tile. In one embodiment, the present coating composition can be used to coat paper intended for rotogravure printing.

The latex coating compositions of the present invention, and the performance of such latex coating compositions in carpet compositions, are illustrated by way of the following non-limiting Examples.

### EXAMPLES

To test wet tuft bind, a piece of carpet is coated with one of the latex coating compositions and dried and cured. A strip is cut and soaked in water for 20 min. Excess water is removed. A eye hook is looped through one tuft on the carpet and the maximum amount of force required to pull the tuft out of the carpet is measured using an Instron machine. Several tufts, from 7 to 10, are pulled and measured for each cut of carpet. The average tuft bind disregards the highest and lowest values. Dry tuft bind is preformed in the same manner but without the soaking and drying.

To test wet pill and fuzz properties—referred to as Velcro™ Ratings, a piece of carpet is coated with one of the latex coating compositions and dried and cured. A strip is cut and soaked in water for 20 min. Excess water is removed. The face of the carpet is then immediately tested for wet pill and fuzz properties using a roller covered with the hook portion of Velcro™ fabric. The Velcro™ fabric covered roller rolls up and down the face of the carpet. The action of the Velcro™ fabric covered roller going up to the top of the carpet and then back to the bottom of the carpet is one cycle. Each sample is tested for 20 cycles. Each sample is rated on a scale between 1 and 5, with 1 being complete fuzzing on the face and failure and 5 demonstrating no fuzzing on the face and thus a longer fail time based on the number of cycles. Dry pill and fuzz performance testing is performed in the same manner but without the soaking and drying.

### Example 1

Several binder emulsions prepared herein are tested for their compatibility with ethylene/acrylic acid polymers (Berbond 8020) and with or without crosslinkers, e.g, ammonium zirconium carbonate (AZC). The first polymer latex used in this example is vinyl acetate/ethylene/butyl acrylate/acrylic acid, except for the Sample 1A which is vinyl acetate/ethylene (86/14) stabilized with PVOH (Dur-O-Set E-190HS-Celanese). Sample 1B is a comparative control of vinyl acetate/ethylene/butyl acrylate/acrylic acid without any additives, e.g., 8020 and AZC. The filler in these examples is Georgia fly ash (Celceram™ PV20A-Boral) at a 200 phr loading, except for the control, which was calcium carbonate at a 270 phr loading. The viscosity and pH of the binder emulsions are also measured in Table 1.

TABLE 1

| | Berbond | | | Viscosity (cps) | | | pH |
|---|---|---|---|---|---|---|---|
| Sam- | 8020 | AZC | | | 24 hr | 1 wk | (1 |
| ple | (phr) | (phr) | Load/Filler | Final | (stirred) | (stirred) | wk) |
| 1A | — | — | 270, CaCO₃ | 5,800 | 9,700 | 4,200 | 6.5 |
| 1B | — | — | 200, GA | 5,600 | 5,700 | 5,400 | 8.5 |
| | | | Fly ash | | | | |
| 1C | 5 | 0.5 | 200, GA | 5,600 | 5,400 | 7,500 | 8.9 |
| | | | Fly ash | | | | |
| 1D | 4 | 0.5 | 200, GA | 5,700 | 5,300 | 5,000 | 8.9 |
| | | | Fly ash | | | | |
| 1E | 3 | 0.5 | 200, GA | 5,200 | 5,100 | 5,100 | 8.8 |
| | | | Fly ash | | | | |
| 1F | 2 | 0.5 | 200, GA | 5,600 | 5,800 | 6,400 | 8.7 |
| | | | Fly ash | | | | |
| 1G | 1 | 0.5 | 200, GA | 5,600 | 5,700 | 6,400 | 8.7 |
| | | | Fly ash | | | | |

The samples from Table 1 were tested for average wet tuft bind as shown in Table 2 and dry and wet pill and fuzz properties according to Velcro™ Ratings as shown in Table 3.

TABLE 2

| | Coat Weight | Average Wet |
|---|---|---|
| Sample | (g/m²) | Tuft Bind (N) |
| 1A | 741.5 | 15.6 |
| 1B | 761.4 | 15.6 |
| 1C | 724.9 | 18.7 |
| 1D | 724.9 | 19.1 |
| 1E | 728.2 | 16.5 |
| 1F | 741.5 | 18.2 |
| 1G | 728.2 | 18.2 |

TABLE 3

| | Coat Weight | | |
|---|---|---|---|
| Sample | (g/m²) | Dry Velcro | Wet Velcro |
| 1A - Control | 731.5 | 4 | 1 |
| 1B | 798 | 5 | 2 |
| 1C | 798 | 5 | 2 |
| 1D | 781.4 | 5 | 4 |
| 1E | 771.4 | 5 | 3 |
| 1F | 798 | 5 | 3 |
| 1G | 771.4 | 5 | 3 |
| 1H | 798 | 5 | 2 |

### Example 2

A latex coating composition was prepared with vinyl acetate/ethylene/butyl acrylate/acrylic acid. In the control, no additives (8020 or AZC) were added. The filler was Georgia fly ash at an initial filler loading of 270 phr. The latex coating compositions having the additives were tested at a filler loading of 270 phr and 350 phr.

TABLE 4

| | | Berbond | | | |
|---|---|---|---|---|---|
| | Filler | 8020 | AZC | Wet Tuft | Dry Tuft |
| Sample | Amount | (phr) | (phr) | Bind (N) | Bind (N) |
| 2A | 270 phr | — | — | 12.5 | 28.5 |
| 2B | 270 phr | 3 | 0.5 | 16.5 | 34.3 |
| 2C | 350 phr | 3 | 0.5 | 13.3 | 24.0 |

When increasing the filler loading from 270 phr as shown in Sample 2A, it would be expected to have a decrease in tuft bind. Thus it is surprising that Sample 2C with the high filler loading also demonstrates an improvement in wet tuft bind. The decrease in dry tuft bind was most likely due to not enough 8020 and/or AZC being added to overcome the extra filler.

### Example 3

A latex coating composition was prepared with vinyl acetate/ethylene/silane/acrylic acid. In Sample 3A no additives (8020 or AZC) were added. The filler was calcium carbonate at a filler loading of 200 phr or 500 phr. The latex coating compositions having the additives were also tested at similar filler loadings. The calcium carbonate filler has a lower pH than Georgia fly ash and the pH was adjusted.

TABLE 5

| | | | | | | | Wet |
|---|---|---|---|---|---|---|---|
| | | Berbond | | | Coat | | Tuft |
| Sam- | Filler | 8020 | AZC | pH | Weight | Dry Tuft | Bind |
| ple | Amount | (phr) | (phr) | adjusted | (g/m²) | Bind (N) | (N) |
| 3A | 200 phr | — | — | — | 768.1 | 25.4 | nt |
| 3B | 200 phr | 3 | 0.5 | No | 781.4 | 29.4 | nt |
| 3C | 200 phr | 3 | 0.5 | Yes | 791.4 | 32.0 | nt |
| 3D | 500 phr | — | — | — | 801.3 | 21.4 | 10.7 |
| 3E | 500 phr | 3 | 0.5 | No | 794.7 | 22.7 | 11.6 |
| 3F | 500 phr | 3 | 0.5 | Yes | 794.7 | 26.2 | 13.3 |

Although wet tuft bind was not tested for Samples 3A-3C, based on the improvements of Samples 3E and 3F over Sample 3D, there would be expected to have a similar improvement in Samples 3B and 3C over Sample 3A. These results unexpectedly demonstrate that the additives 8020 and AZC results in improvements in dry tuft bind for Samples 3B and 3C.

### Example 4

A latex coating composition was prepared with a 50/50 blend of vinyl acetate/ethylene/silane/acrylic acid and styrene-butadiene (Rovene™ 4487). Each sample in Table 6 had a filler loading of 200 phr.

TABLE 6
50/50 of VAE/SBR

| | Berbond | | | Coat | | |
|---|---|---|---|---|---|---|
| | 8020 | AZC | | Weight | Dry Tuft | Wet Tuft |
| Sample | (phr) | (phr) | pH | (g/m²) | Bind (N) | Bind (N) |
| 4A | — | — | 7.4 | 768.1 | 25.4 | 12.5 |
| 4B | 3 | 0.5 | 9.2 | 781.4 | 46.7 | 23.1 |

Sample 4B in Table 6 demonstrated an 84% improvement in dry tuft bind over Sample 4A and an 82% improvement in wet tuft bind.

### Example 5

A latex coating composition was prepared with vinyl acetate/ethylene/silane/acrylic acid. Filler loading for precoat applications of either 200 phr or 500 phr and for skip coat application of 400 phr. The average for both precoat and skip coat applications was used for filler loads of 500 phr and 400 phr.

TABLE 7

| | | | | | | | Dry | Wet |
|---|---|---|---|---|---|---|---|---|
| | Filler | | | Precoat | Skip Coat | | Tuft | Tuft |
| Sam- | Amount | 8020 | AZC | Weight | Weight | | Bind | Bind |
| ple | (phr) | (phr) | (phr) | (g/m²) | (g/m²) | pH | (N) | (N) |
| 5A | 500/400 | — | — | 801.3 | 299.3 | nt | 21.4 | 10.7 |
| 5B | 500/400 | 3 | 0.5 | 794.7 | 302.6 | 8.3 | 20.0 | 11.6 |
| 5C | 500/400 | 3 | 0.5 | 794.7 | 309.2 | 9.1 | 20.9 | 13.3 |
| 5D | 500/400 | 5 | 0.5 | 798 | 289.3 | 9.2 | 22.7 | 11.1 |
| 5E | 500/400 | 3 | 1 | 798 | 276 | 9.1 | 19.6 | 7.6 |
| 5F | 500/400 | 3 | 1 | 798 | 272.7 | 9.2 | 23.6 | 8.9 |
| 5G | 500/400 | 3 | 0 | 794.7 | 279.3 | 9.1 | 26.2 | 10.7 |
| 5H | 200 | — | — | 768.1 | — | 7.4 | 25.4 | 12.5 |
| 5I | 200 | 3 | 0.5 | 781.4 | — | 7.3 | 29.4 | 12.5 |
| 5J | 200 | 3 | 0.5 | 791.4 | — | 9.1 | 32.0 | 12.0 |

The stirred viscosity of samples after 1 week for Samples 5D, 5E, and 5F, at 500 phr filler loading, was 96,000 cps, 140,000 cps, and 48,000 cps, respectively. In additions, Samples 5E and 5F did not demonstrate sufficient stability. The remaining samples after 1 week had a stirred viscosity of less than 45,000 cps.

While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of the patentable novelty which reside in the present disclosure, including all features which would be treated as equivalents thereof by those skilled in the art to which the disclosure pertains.

1. A carpet product comprising at least one substrate and at least one adhesive layer adhered to the at least one substrate, the adhesive layer being formed from a latex coating composition comprising:
a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides;
a second polymer formed from an α-olefin and ethylenically unsaturated carboxylic acids; and
at least one external crosslinker.

2. The carpet product of claim 1, wherein the composition comprises from 50 to 500 parts filler per 100 parts of the total polymer.

3. The carpet product of claim 1, wherein the ethylenically unsaturated carboxylic acids has a formula of: 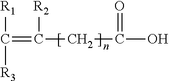
wherein R₁ is hydrogen or C₁-C₁₆ alkyl,
R₂ and R₃ are independently selected from hydrogen, C₁-C₁₆ alkyl, carboxylic acid moiety or C₁-C₁₆ alkyl carboxylic acid moiety; and
n is 0 or 1.

4. The carpet product of claim 1, wherein the first polymer comprises at least one vinyl monomer of a vinyl ester of a C₁-C₁₈ alkanoic acid or vinylaromatic.

5. The carpet product of claim 1, wherein the first polymer comprises a vinyl ester of a C₁-C₁₈ alkanoic acid, and an α-olefin.

6. The carpet product of claim 5, wherein the α-olefin is ethylene and the first polymer comprises from 2 to 30 parts per hundred of ethylene based on total monomers in the first polymer.

7. The carpet product of claim 1, wherein the second polymer comprises an ethylene acrylic acid polymer, and wherein the ethylene acrylic acid polymer comprises from 70 to 90 parts per hundred of ethylene based on total monomers in the second polymer.

8. The carpet product of claim 1, wherein the composition comprises at least 1 part of the second polymer per 100 parts of the total polymer.

9. The carpet product of claim 1, wherein the at least one crosslinker is selected from the group consisting of ammonium zirconium carbonate, zinc ammonium carbonate, potassium zirconium carbonate, and titanium acetylacetonate, ethylcitrate zirconate, alkanolamine titanate, alkanolamine zirconates, and titanium lactates.

10. The carpet product of claim 1, wherein the composition comprises from 0.1 to 10 parts crosslinker per 100 parts of the total polymer.

11. The carpet product of claim 1, wherein the coating composition further comprising a filler selected from the group consisting of calcium carbonate, aluminum trihydrate, barite, feldspar, cullet, fly ash and/or recycled carpet backing.

12. The carpet product of claim 11, wherein the composition comprises from 50 to 500 parts filler per 100 parts of the total polymer.

13. A process for producing a carpet product comprising:
providing yarns which are tufted into a primary backing material;
applying a binder emulsion composition to the backing material, wherein the binder emulsion comprises:
a first polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and amides of ethylenically unsaturated carboxylic acids;
a second polymer formed from an α-olefin and ethylenically unsaturated carboxylic acids; and
at least one crosslinker; and
drying the binder emulsion composition under conditions effective to adhere the tufted yarns into the backing material.

14. A latex coating composition comprising:
a first polymer formed from one or more monomers selected from the group consisting of vinyl esters of a C₁-C₁₈ alkanoic acid, ethylenically unsaturated carboxylic acids, and esters of ethylenically unsaturated carboxylic acids;
a second polymer formed from ethylene and acrylic acid; and
optionally at least one external crosslinker.

15. A latex coating composition comprising:
a first polymer comprising a blend of:
a first blend polymer formed from one or more monomers selected from the group consisting of vinyl esters of a C₁-C₁₈ alkanoic acid, ethylenically unsaturated carboxylic acids, esters of ethylenically unsaturated carboxylic acids, vinylaromatics, and vinyl halides; and
a second blend polymer formed from a vinylaromatic and a diene;
a second polymer formed from an α-olefin and an ethylenically unsaturated carboxylic acid; and
at least one external crosslinker.

16. The latex coating composition of claim 15, wherein the first polymer comprises a weight ratio of first blend polymer to second blend polymer of 40/60 to 60/40.

17. The latex coating composition of claim 15, wherein the second blend polymer comprises styrene and 1,3-butadiene.

18. The latex coating composition of claim 15, wherein the second polymer comprises an ethylene acrylic acid polymer, and wherein the ethylene acrylic acid polymer comprises from 70 to 90 parts per hundred of ethylene based on total monomers in the second polymer.
